(19) United States
(12) Patent Application Publication
(10) Pub. No.: US 2018/0282673 A1
(43) Pub. Date: Oct. 4, 2018

(54) DETERGENT PRODUCT

(71) Applicant: Henkel AG & Co. KGaA, Duesseldorf (DE)

(72) Inventors: Frank Meier, Duesseldorf (DE); Katja Gerhards, Duesseldorf (DE); Matthias Sunder, Duesseldorf (DE)

(73) Assignee: Henkel AG & Co. KGaA, Duesseldorf (DE)

(21) Appl. No.: 15/935,784

(22) Filed: Mar. 26, 2018

(30) Foreign Application Priority Data
Mar. 31, 2017 (DE) 102017205547.2

(51) Int. Cl. C11D 17/04

(52) U.S. Cl. CPC C11D 17/045

(57) ABSTRACT

A detergent product for treating textiles, including a film pouch having a plurality of pouch chambers which are each enclosed by at least one water-soluble film, wherein the pouch chambers are formed by water-soluble films connected to one another in a sealing plane and are separated from one another by sealing sections located in the sealing plane, and wherein the pouch chambers are each filled with a detergent preparation. For intrinsic shape stability of the detergent product and for appearance of the multi-chamber arrangement, a plurality of pouch chambers which are located one after the other are provided in a number n where n≥3, which pouch chambers are arranged as a finite series of pouch chambers with a monotonously increasing size of the footprints of the pouch chambers located in the sealing plane and/or with a monotonously increasing size of the fill volumes of the pouch chambers.

### FIELD OF THE INVENTION

The invention relates to a detergent product, in particular for treating textiles, more particularly for cleaning textiles and/or washing textiles, comprising a film pouch having a plurality of pouch chambers which are each enclosed by a water-soluble film, wherein the pouch chambers are formed by water-soluble films connected to one another in a sealing plane and are separated from one another by sealing sections located in the sealing plane, and wherein the pouch chambers are each filled with a detergent preparation.

### BACKGROUND OF THE INVENTION

Water-soluble detergent products in the form of a single-use portion pack for treating textiles are known. Such a portion pack is used only once for treating textiles, usually in a textile washing machine. The detergent product comprises a film pouch having one or more pouch chambers. Accommodated in each pouch chamber is a detergent preparation which contains active washing substances for treating textiles, in particular for washing textiles. The use of multiple pouch chambers opens up the possibility of separately holding different detergent preparations which under some circumstances chemically react with one another or are not storage-stable for other reasons when mixed together. In addition, the use of multiple different detergent preparations within one wash cycle permits the release of multiple, functionally different washing substances and/or additive substances, such as for example bleaches, fabric softeners or fragrances. If multiple pouch chambers are provided, the individual detergent preparations within the pouch chambers may have an identical or different consistency and are preferably of liquid consistency, for example liquid, gel-like, pasty or wax-like, or of solid consistency, for example in powder, granule, free-flowing or solid form.

Once the detergent products in question have been added to water, the film dissolves and releases the detergent preparation. The film pouch may be formed of a plurality of water-soluble films, the water-soluble film preferably being PVA film (polyvinyl alcohol film). The films that can be used usually consist of polyvinyl alcohol copolymers with suitable additives such as plasticizers, water, surfactants, bittering agents, antioxidants, slip agents, release agents, or salts. The film pouch may be manufactured from a water-soluble base film and a water-soluble cover film, which form the boundary walls of at least one pouch chamber. The base film may for example be deep-drawn in a plastically deforming manner in order to form at least one pouch chamber. The base film and the cover film are then sealed to one another or connected to one another in one or more sealing or connecting sections. The sealing sections are then located in a so-called sealing plane or connecting plane of the two films.

Detergent products having multiple pouch chambers are known for example from DE 10 2014 102 567 A1. The detergent product described in the aforementioned document may comprise a plurality of chambers which may be arranged in a manner aligned above each other, that is to say positioned one above the other. Arrangements in which the chambers are arranged alongside one another, that is to say positioned one next to the other, are also possible. Chambers may also be arranged in such a way that a first chamber is located next to a second chamber, but the first chamber at least partially surrounds the second chamber but does not completely enclose the second chamber. Alternatively, one chamber may also be completely enclosed by another chamber. The chambers may be of different sizes and may each contain a laundry washing, textile care or dishwashing composition, including pretreatment or soaking compositions and other washing compositions. The composition may also be a detergent composition or a machine dishwashing composition. The detergent composition may be used during the main wash cycle or it may be used as a pretreatment or soaking composition.

A detergent product comprising a water-soluble pouch which has a plurality of pouch chambers arranged next to one another is known for example from EP 2 617 659 B1. Two separate chambers are each filled with a cleaning agent, wherein the film pouch is manufactured from a water-soluble base film and a water-soluble cover film which are sealingly connected to one another in a sealing plane. The pouch chambers are separated from one another by sealing sections located in the sealing plane. The base film is deep-drawn in a plastically deforming manner in order to form the pouch chambers. In the sealing plane, a first pouch chamber has a first footprint and a second pouch chamber has a second footprint. The film pouch has a third footprint, wherein the first footprint of the first pouch chamber has a concave section on its side facing toward the second pouch chamber, and wherein the second footprint of the second pouch chamber has a convex section on its side facing toward the first pouch chamber. The convex section of the second pouch chamber extends into the concave section of the first pouch chamber. The second footprint of the second pouch chamber has at least one concave section to the side of its convex section, said concave section being adjacent to at least one convex section of the first footprint. This geometry is intended to achieve a certain intrinsic shape stability of the film pouch, so that the pouch chambers do not fold and bend relative to one another when the film pouch is manually held. This is because folding or bending of the pouch chambers will often be interpreted by users of the detergent products in question to be an indication of supposedly poor product quality.

Detergent products which have pouch chambers of geometrically simple design arranged next to one another usually have an insufficient intrinsic shape stability of the film pouch, with the result that such product designs are considered by users to be of inferior quality. In addition, a low shape stiffness of the detergent product is associated with unsatisfactory processability during manufacture and further processing of the products.

From the user's point of view, a large footprint of the film pouch and wide sealing sections between the pouch chambers may make it questionable whether the detergent product will (completely) dissolve during a wash cycle. In fact, the dissolution behavior of multi-chamber capsules, that is to say the rate of dissolution and the degree of dissolution during a wash cycle, often does not meet the high expectations of consumers of water-soluble detergent products. The pouch chambers of known multi-chamber capsules form attachment surfaces for parts of laundry items, such as buttons or appliques, which leads to the detergent product becoming caught in the laundry and then being transported along with an item of laundry. This can lead to an uneven and poor flow around the detergent product during a wash cycle and thus to a delayed and insufficient dissolution of the film material, in particular of the sealing seams in the middle region of the film pouch. The geometry and shape of the pouch chambers also contribute to a non-optimal dissolution behavior of the known detergent products, wherein, between adjacent pouch chambers, regions form which are exposed to a poorer flow and which are not sufficiently dissolved at the end of a wash cycle.

It is true that the product design of water-soluble multi-chamber capsules permits designs which from the user's point of view are perceived as esthetically more pleasing than single-chamber capsules and as a sign of an innovative product concept. However, the film consumption for producing multi-chamber capsules is around 10 to 50% greater than the film consumption for producing single-chamber systems with the same total amount of detergent preparation contained in the pouch chamber or pouch chambers. The higher film consumption can be attributed to the use of a third film layer for producing the chambers in the case of detergent products having a plurality of chambers arranged one above the other, and to a non-optimized shaping of adjacent pouch chambers with wide sealing sections between the chambers in the case of detergent products having pouch chambers arranged next to one another. The higher film consumption leads to higher production costs. Moreover, a high film consumption is in conflict with an ever-increasing environmental awareness of users and the desire for resource-saving production processes.

### BRIEF SUMMARY OF THE INVENTION

Proceeding from the prior art described above, the problem addressed by the invention is that of providing a generic detergent product which has a high intrinsic shape stability and enables improved use particularly in textile washing machines, which also includes in particular an improved dissolution behavior during the washing process. The detergent product according to the invention should be characterized in particular by a high rate of dissolution and a largely residue-free dissolution during a predefined wash cycle in a textile washing machine. In addition, the detergent product should be easy to manufacture in an inexpensive and resource-saving manner while exhibiting good processability and should satisfy the high demands of users for an innovative product design.

In order to solve the aforementioned problem, there is proposed in a detergent product a plurality of pouch chambers which are located one after the other in a number n where n≥3, which pouch chambers are arranged as a (finite) series of pouch chambers with a monotonously increasing size of the footprint located in the sealing plane and/or with a monotonously increasing size of the fill volume. In a series of pouch chambers having n elements arranged successively, where n≥3, the footprint and/or the fill volume of each subsequent pouch chamber in the series is larger than or identical to the footprint and/or the fill volume of the adjacent preceding pouch chamber. By way of example, in a series of pouch chambers located one after the other, the first pouch chamber may have the smallest footprint and/or the smallest fill volume and a second pouch chamber may have a larger footprint and/or a larger fill volume. A third subsequent pouch chamber may then in turn have for example an identical footprint and/or an identical fill volume to that of the second pouch chamber or else a larger footprint and/or a larger fill volume. A fourth pouch chamber of the series may then have for example a maximum footprint and/or a maximum fill volume.

In the context of the invention, the term “detergent product” is to be understood in the broad sense and also includes in particular those products which are used for cleaning dishes in dishwashers. The term “detergent preparation” is thus likewise to be understood in the broad sense and also includes for example machine dishwashing detergents and rinse aids. The following observations relating to the use of the detergent product according to the invention in textile washing machines also apply accordingly to embodiments of the detergent product according to the invention for use in dishwashers, without this being discussed in detail.

When producing the pouch chambers by plastic deformation of a base film in a deep-drawing die and bonding to a cover film, the shape and size of the footprints in the sealing plane are predefined by the contour of the opening of the cavities of the deep-drawing die.

The inventive arrangement of the pouch chambers on the film pouch as a series of pouch chambers with a monotonously increasing size of the footprints and/or with a monotonously increasing size of the fill volumes leads to a number of advantages.

A product design which is characterized by high intrinsic stability is possible. By arranging the pouch chambers in a particular order according to the size of their footprints and/or the size of their fill volumes, the folding or bending of the pouch chambers relative to one another during production, processing and use can be considerably reduced, so that the processability is improved and the detergent product according to the invention is perceived by users as being of particularly high quality.

In addition, by virtue of the inventive arrangement of the pouch chambers in a particular order according to the size of their footprints and/or the size of their fill volumes, an esthetically pleasing product design can be achieved, which contributes to a high level of user acceptance.

The pouch chambers can be configured in a flow-optimized manner and arranged relative to one another in a flow-optimized manner which, when used in a textile washing machine, leads to an even and intensive flow around and over the pouch chambers in combination with a fast and largely complete dissolution of the film material. By arranging pouch chambers with a monotonously increasing size of the footprints of the pouch chambers and/or with a monotonously increasing size of the fill volumes, fewer attachment surfaces are created for laundry parts, such as buttons and/or appliques. Laundry parts therefore do not become so easily caught between adjacent pouch chambers, so that the detergent products according to the invention are moved more intensively during a wash cycle, thereby ensuring sufficient contact with water during the wash cycle.

Finally, embodiments of the product design, that is to say certain configurations of the shape and size of the pouch chambers and certain arrangements of the pouch chambers relative to one another, are possible which are characterized by a very compact structure. The compact structure leads to reduced material consumption. Production and packaging processes are simplified.

The product design may provide very narrow sealing sections between adjacent chambers, which leads to a reduction in the dimensions of the detergent product according to the invention and thus enables optimal use of the capacities of the apparatus and machines used for producing and transporting the detergent products. The external appearance of the detergent products is also enhanced.

The pouch chamber may be formed by at least two, preferably only two, film layers which are sealed to one another in one or more sealing sections. Preferably, only pouch chambers which are arranged next to one another and which are separated from one another are provided, and no superposed/overlapping pouch chambers are provided, so that it is possible to produce the film pouch using only two film layers. This leads to reduced production costs and to a reduced production complexity. The film pouch may be manufactured from a water-soluble base film and a water-soluble cover film, which are sealingly connected to one another in the sealing plane. The base film may be deep-drawn in a plastically deforming manner in order to form pouch chambers.

The pouch chambers are separated from one another by sealing sections located in the sealing plane. The sealing sections may in particular be formed to run in a non-rectilinear manner and thus ensure a desired high intrinsic shape stability of the detergent product.

The outer contour of the film pouch in the sealing plane, or the footprint of said film pouch, may preferably be circular, triangular or quadrangular. Shaping may take place for example by laser cutting or punching. Other outer contours of the film pouch are not ruled out.

In one particularly preferred embodiment, the pouch chambers of the series are located one after the other in the circumferential direction of the film pouch. The pouch chambers may be arranged around a middle region of the film pouch in a manner distributed around the circumference of the film pouch, so that the footprint and/or the fill volume of each subsequent pouch chamber of the series in the circumferential direction of the film pouch is larger than the footprint and/or the fill volume of the adjacent preceding pouch chamber or is identical to the footprint and/or the fill volume of the adjacent preceding pouch chamber. This applies until the largest pouch chamber is reached, which is then adjacent to the smallest. The arrangement of the pouch chambers follows circumferentially the outer contour of the film pouch in the sealing plane.

Depending on the contour of the film pouch in the sealing plane, the pouch chambers may be arranged for example on a substantially circular or polygonal path circumferentially around a middle region of the film pouch. However, a rectilinear, spiral, zig-zag, wavy or stepped arrangement of pouch chambers with a monotonously increasing size of the footprint and/or with a monotonously increasing size of the fill volume is not ruled out.

The number of pouch chambers located one after the other and forming a series may be between three to nine, preferably three or four, pouch chambers. Preferably, all pouch chambers of the film pouch form the series of pouch chambers that is provided according to the invention.

A certain number of pouch chambers of the series may have footprints of identical size and/or fill volumes of identical size. In the series of pouch chambers, preferably m pouch chambers, where m≤n, preferably where m=2, are provided which have an identical size of the footprint and/or of the fill volume. More preferably, however, less than half of all n pouch chambers have an identical size of the footprint and/or an identical size of the fill volume.

In one particularly preferred embodiment, an arrangement of at least three pouch chambers is provided as a series of pouch chambers with a strictly monotonously increasing size of the footprint and/or of the fill volume. In this case, the footprint and/or the fill volume of each subsequent pouch chamber of the series is larger than the footprint and/or the fill volume of the adjacent preceding pouch chamber.

Particularly those product designs in which the change in the size of the footprint and/or in the size of the fill volume of the pouch chambers follows a mathematical function are able to achieve the advantages described above and in particular meet high demands for an esthetic appearance of the detergent product. In this connection, the invention may provide that the increase in the size of the footprint and/or the increase in the size of the fill volume in the series of n pouch chambers corresponds to the formation rule for a sequence of numbers. A “formation rule” is to be understood to mean a mathematical function which clearly describes a mathematical relationship between the position and/or arrangement of the respective pouch chamber in the series of n pouch chambers and the size of the footprint and/or volume of the respective pouch chamber.

By way of example, the increase may correspond to an arithmetic sequence of numbers, wherein the difference in the size of the footprint and/or in the fill volume is the same from pouch chamber to pouch chamber for all pouch chambers of the series. This can be expressed for example, in the case of strictly monotonously increasing fill volumes of the pouch chambers, by formation rule (I):

Vₙ₊₁=Vₙ+D (I)

where
Vₙ=fill volume of a preceding pouch chamber of the series of n pouch chambers
Vₙ+1=fill volume of a subsequent pouch chamber of the series
D=constant difference in volume between the pouch chambers in question

The increase in the size of the footprint and/or in the size of the fill volume from pouch chamber to pouch chamber in the series may also correspond to a geometric sequence of numbers, wherein, for the successive pouch chambers, the quotient of the footprints and/or of the fill volumes is always the same for all n pouch chambers of the series. This can be expressed by the following formation rule (II):

Vₙ₊₁=Vₙ*q (II)

where
Vₙ=fill volume of a preceding pouch chamber of the series of n pouch chambers
Vₙ₊₁=fill volume of a subsequent pouch chamber of the series
q=quotient of Vₙ+1/Vₙ, which is always constant

Another advantageous product design may provide that the increase in the size of the footprint and/or in the size of the fill volume from pouch chamber to pouch chamber correlates with the sequence of prime numbers or with the Fibonacci sequence of numbers or even corresponds to said sequences of numbers. In a design correlating with the sequence of prime numbers and consisting of four pouch chambers for example which are arranged one after the other, the volume of the second pouch chamber may for example correspond to three times the volume of the first pouch chamber, and the volume of the third pouch chamber may correspond to five times the volume of the first pouch chamber. The volume of the fourth pouch chamber may correspond to seven times the volume of the first pouch chamber.

In addition, the increase in the size of the footprint and/or the increase in the size of the fill volume in the series of pouch chambers may correspond to a sequence of numbers in which the difference in the size of the footprint and/or in the size of the fill volume is not the same for all pouch chambers of the series, which for example in the case of a strictly monotonously increasing fill volume of the pouch chambers of the series can be expressed by formation rule (III):

Vₙ₊₁=Vₙ+D (III)

where
Vₙ=fill volume of a preceding pouch chamber of the series of n pouch chambers
Vₙ₊₁=fill volume of a subsequent pouch chamber of the series
D=non-constant difference in volume between the pouch chambers in question

By way of example, the volume of each subsequent pouch chamber in the series of n pouch chambers may correspond to a non-constant multiple of the volume of the first pouch chamber.

The fill volume of the smallest pouch chamber may be between 40 and 80%, preferably between 50 and 70%, more preferably between 55 and 65%, of the fill volume of the largest pouch chamber. The fill volume of a medium-sized pouch chamber may be between 50% and 90%, preferably between 60% and 80%, more preferably between 65% and 75%, of the fill volume of the largest pouch chamber. It will be understood that a plurality of “medium-sized” pouch chambers may be provided. The above-described advantages of the detergent product according to the invention can be achieved particularly well in this way.

As already mentioned, a further formation rule (IV) can be derived from the recursion rule for the Fibonacci numbers, wherein the volume ratios of directly successive pouch chambers are formed by factors of the Fibonacci numbers an:

Vₙ₊₁=Vₙ*aₙ

Vₙ₊₂=Vₙ₊₁*aₙ₊₁

Vₙ₊₃=Vₙ₊₂*aₙ₊₂ (IV)

where
Vₙ=fill volume of a preceding pouch chamber of the series of n pouch chambers
V_{n+1, n+2, n+3}=fill volume of a subsequent pouch chamber of the series
aₙ=Fibonacci number

It is advantageous if at least two pouch chambers of the series of n pouch chambers, preferably all pouch chambers, have footprints of different shape.

In order to solve the problem stated above, it is also advantageous if the footprint of the pouch chamber is axially asymmetrical. The footprint then cannot be imaged onto itself by a perpendicular axis reflection at a mirror axis running through the footprint. By virtue of the axial asymmetry, it is possible to achieve flow conditions at the pouch chamber which lead to an improved and more even dissolution of the film material when the detergent product is used in a wash cycle. In addition, by virtue of a particular arrangement of the pouch chambers relative to one another, a compact structure of the film pouch can be achieved, wherein the width of the sealing sections between adjacent pouch chambers can be reduced. A modern product design with unusual pouch chamber shapes is possible, which draws the user's attention to the pouch chambers and the contents thereof. This helps to achieve a high level of consumer acceptance for the detergent product according to the invention. Against this background, one preferred embodiment of the invention provides droplet-shaped, leaf-shaped or yin-and-yang-shaped footprints of the pouch chambers.

One particularly preferred contour of the pouch chamber in the sealing plane is characterized by a narrow convex end section and, opposite this in the longitudinal direction of the pouch chamber, a wide convex end section of the contour. The contour may be characterized by a first circular shape of smaller inner radius located at the narrow end section and by a second circular shape of larger inner radius located at the wider end section, wherein the ratio of the larger inner radius to the smaller inner radius may be for example more than 3:1, preferably more than 5:1, more preferably more than 8:1, or even more than 12:1. When producing the film pouch in a deep-drawing mold, the inner radii are predefined by the cavities of the deep-drawing mold. Between the narrow convex end section and the wide convex end section, the contour may be provided by a concave or straight inner section directed toward the middle of the film pouch and by a convex or straight outer section directed toward the outer edge of the film pouch, resulting in a droplet-shaped, leaf-shaped or yin-and-yang-shaped footprint of the pouch chamber.

One advantageous design of the pouch chamber contour in the sealing plane may provide that in each case a wide convex end section of the contour of a first pouch chamber is adjacent to or is located opposite a concave or straight inner section and/or a narrow convex end section of the contour of an adjacent second pouch chamber. As an alternative or in addition, the narrow convex end section of the contour of the second pouch chamber may also engage partially around the outside of the wide convex end section of the contour of the adjacent first pouch chamber. As an alternative or in addition, the wide convex end section of the contour of the first pouch chamber may intersect a tangent which is placed at the wide convex end section and at the narrow convex end section of the contour of the adjacent second pouch chamber. The wide convex end section of the first pouch chamber then extends into a concave region of the contour of the second pouch chamber. The contours described above permit a product design which is characterized by a very compact arrangement of the pouch chambers on the film pouch.

The pouch chambers may also be arranged in a rotationally asymmetrical manner. The footprints of the pouch chambers are then not arranged around a common n-fold axis of rotation perpendicular to the sealing plane. This means that the arrangement of the pouch chambers (with reference to the footprints) when rotated about an axis of rotation through 360°/n (where n is the number of pouch chambers) in each case differs significantly from the arrangement prior to the rotation of the film pouch or detergent product. The footprints of the n pouch chambers of the series thus cannot be brought into line with themselves by rotating the film pouch through a particular angle 360°/n, and no symmetry-equivalent or substantially congruent arrangements of the footprints are obtained. The non-rotationally asymmetrical arrangement of the footprints may promote a turbulent flow around the pouch chambers when used in a textile washing machine, so that the time taken for the detergent product according to the invention to dissolve is reduced and the degree of dissolution at the end of a wash cycle is increased. Consumer acceptance of the use of the detergent products according to the invention is therefore high.

In particular, the transitions of the pouch chambers in the circumferential direction of the film pouch may be characterized by narrow sealing sections. Particularly in the radially outer regions between two adjacent pouch chambers, the sealing sections may have a maximum width of less than 5 mm, preferably of less than 3 mm, more preferably of only 2 mm or less. The detergent product can therefore less easily become caught on parts of laundry. This results in intensive contact of the film pouch with the laundry drum and with the laundry during a wash cycle, which results in an improved dissolution behavior of the film pouch. In addition, a higher intrinsic stability of the detergent product can thus be achieved. From the user's point of view, the product design can be made modern and interesting due to the unusual shape of the pouch chambers, wherein the user barely notices narrow sealing sections between the pouch chambers and the user's attention is drawn to the pouch chamber and the contents thereof.

In order to achieve the most homogenous possible flow over the pouch chambers and a good dissolution behavior as well as a high intrinsic shape stability with the narrowest possible sealing sections between the pouch chambers, the outer sections of the contours of the pouch chambers in the sealing plane may be located at least substantially on a common circumferential line, which may have a substantially circular, elliptical, super-elliptical, square, rectangular or triangular shape.

In connection with the invention, it has been found that particularly advantageous flow conditions at the pouch chambers and an overall very good dissolution behavior of the film pouch can be achieved if an area bisector of the footprint of a pouch chamber in the sealing plane turns to the left or to the right and if, preferably, a left-turning or right-turning arrangement of all pouch chambers is provided. The footprints of all pouch chambers may have outer contours and/or inner contours with the same direction of curvature at least in some sections. The area bisectors of all pouch chambers of the film pouch are then bent in the same direction, that is to say either to the left or to the right, which leads to an esthetically pleasing appearance of the detergent product according to the invention. In addition, curving the pouch chambers in the same direction may help the detergent product to come into intensive contact with the items of laundry in the washing drum and to “migrate through” the laundry without becoming caught on particular items of laundry.

For an improved dissolution behavior, particular advantage is achieved by a shape of the footprint of the pouch chamber, located in the sealing plane, in which the width of the footprint transverse to the area bisector first increases continuously along the area bisector from a narrow convex end section of the contour of the pouch chamber in the sealing plane toward an opposite wide convex end section of the contour, until a maximum value of the width is reached. The width may then decrease again toward the wide convex end section. Correspondingly, the cross-sectional area of the pouch chamber perpendicular to the sealing plane may increase continuously along the area bisector from the narrow convex end section of the contour until a maximum value is reached, and then may decrease again until the wide convex end section is reached. The pouch chamber may then have a helical structure both in two-dimensional space in the sealing plane and in three-dimensional space. In this case, the cross-sectional area of the pouch chamber may first increase over a relatively long section of the area bisector until the maximum value is reached and then may decrease again over a shorter section after reaching the maximum value. The same may apply to the width of the footprint.

The subsequent pouch chamber may then follow with a similar cross-sectional profile, wherein the maximum cross-sectional area of a subsequent pouch chamber in the series may be larger than the maximum cross-sectional area of a preceding pouch chamber in the series or may be of identical size. If the contour of the pouch chamber in the sealing plane has a narrow convex end section and a wide convex end section located opposite the narrow convex end section, the maximum cross-section or the maximum width of the pouch chamber may lie in the region of the mid-point of a circular arc placed from the inside against the wide convex end section.

In order to achieve stronger turbulence in the middle region of the film pouch, at least one central chamber may be provided which is arranged in the middle region of the film pouch, wherein the pouch chambers are then arranged around the central chamber. The dissolution behavior of the detergent product is thus optimized, and a high intrinsic stability against undesired folding of the pouch chambers is achieved.

The central chamber is separated from each pouch chamber by a sealing section, wherein the central chamber may be at an equal distance from each pouch chamber. The minimum width of the sealing section between a pouch chamber and the central chamber may be less than 5 mm, preferably less than 3 mm, more preferably less than 2 mm. It is thus possible to achieve a high intrinsic shape stability and a compact product design that is appealing from the user's point of view.

The central chamber can take its place in the series of pouch chambers with a monotonously increasing size of the footprints located in the sealing plane and/or with a monotonously increasing size of the fill volumes and may form for example the first or last element of the series. The central chamber and the pouch chambers may form a (finite) series of chambers located directly one after the other with a monotonously increasing size of the footprints of the chambers located in the sealing plane and/or with a monotonously increasing size of the fill volumes of the chambers. The total number of chambers (pouch chambers, central chamber) of the film pouch may lie in the range between three and ten chambers, preferably in the range between three and five chambers.

The pouch chambers may be at a minimum distance from the contour line of the central chamber which changes along their contour lines but is preferably equal for all pouch chambers. The contour line of the central chamber may be matched to the contour line of the adjacent pouch chambers in order to achieve the narrowest possible sealing sections between the chambers. The central chamber may have a circular footprint or polygonal footprint in the sealing plane, for example a square, triangular, star-shaped, propeller-shaped or fan-wheel-shaped footprint. The footprint of the central chamber may also have an asymmetrical shape.

The method for producing the detergent product according to the invention and also the water-soluble films used for producing the product are generally known to a person skilled in the art. Examples of preferred polymers, copolymers or derivatives which are suitable for use as pouch chambers, as well as suitable detergent preparations, are described in DE 10 2014 102 567 A1. The content of the disclosure of the aforementioned document is hereby incorporated in the content of the disclosure of the description of the present invention.

### BRIEF DESCRIPTION OF THE DRAWINGS

The invention will be explained in greater detail below by way of example and with reference to the figures. The features mentioned and described above and also the features shown in the drawing and described below can be combined as required, even if this is not shown in detail. The invention is not limited to the features and combinations of features shown in the figures.

In the figures:

FIG. 1 shows a first embodiment of a detergent product according to the invention comprising a film pouch having four pouch chambers, in a perspective view at an angle from above;

FIG. 2 shows a plan view of the footprints of the pouch chambers and of the footprint of the film pouch in the sealing plane of the detergent product shown in FIG. 1;

FIG. 3 shows a view from below of the footprints of the pouch chambers and of the footprint of the film pouch in the sealing plane of the detergent product shown in FIG. 1;

FIG. 4 shows a side view of the detergent product shown in FIG. 1, in the viewing direction illustrated by I in FIG. 2;

FIG. 5 shows a side view of the detergent product shown in FIG. 1, in the viewing direction illustrated by II in FIG. 2;

FIG. 6 shows a side view of the detergent product shown in FIG. 1, in the viewing direction illustrated by III in FIG. 2;

FIG. 7 shows a side view of the detergent product shown in FIG. 1, in the viewing direction illustrated by IV in FIG. 2;

FIG. 8 shows another embodiment of a detergent product according to the invention comprising a film pouch having three pouch chambers, in a perspective view at an angle from above;

FIG. 9 shows a plan view of the footprints of the pouch chambers and of the footprint of the film pouch in the sealing plane of the detergent product shown in FIG. 8;

FIG. 10 shows a view from below of the footprints of the pouch chambers and of the footprint of the film pouch in the sealing plane of the detergent product shown in FIG. 8;

FIG. 11 shows a side view of the detergent product shown in FIG. 8, in the viewing direction illustrated by I in FIG. 9;

FIG. 12 shows a side view of the detergent product shown in FIG. 8, in the viewing direction illustrated by II in FIG. 9;

FIG. 13 shows a side view of the detergent product shown in FIG. 8, in the viewing direction illustrated by III in FIG. 9; and

FIG. 14 shows a side view of the detergent product shown in FIG. 8, in the viewing direction illustrated by IV in FIG. 8.

### DETAILED DESCRIPTION OF THE INVENTION

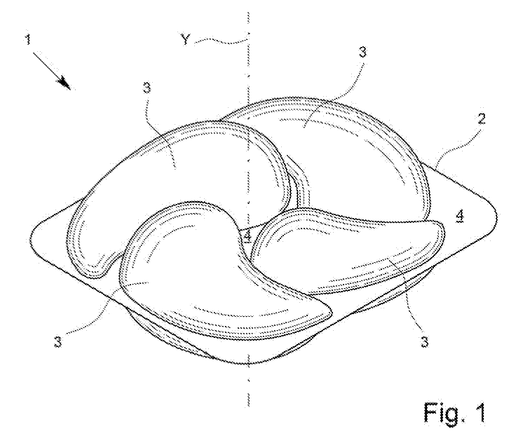

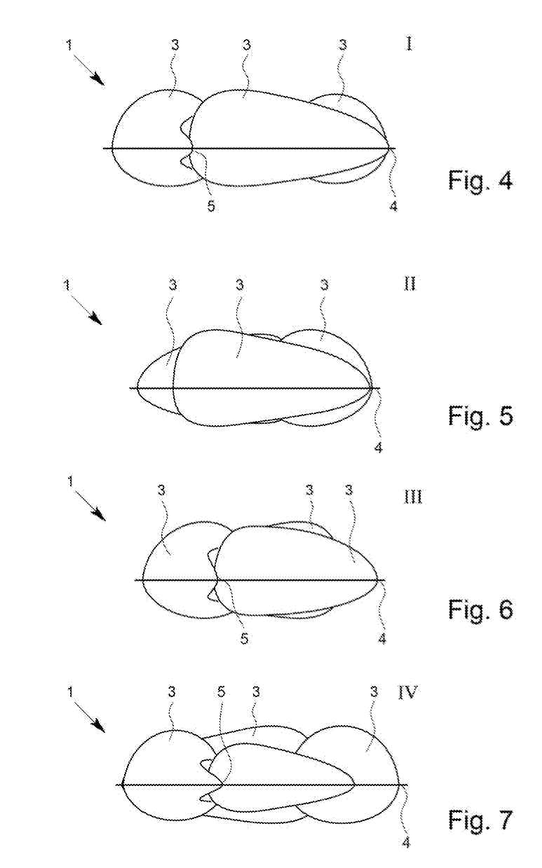

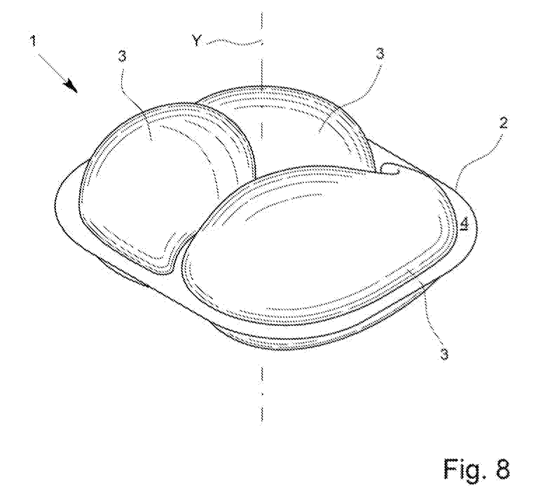

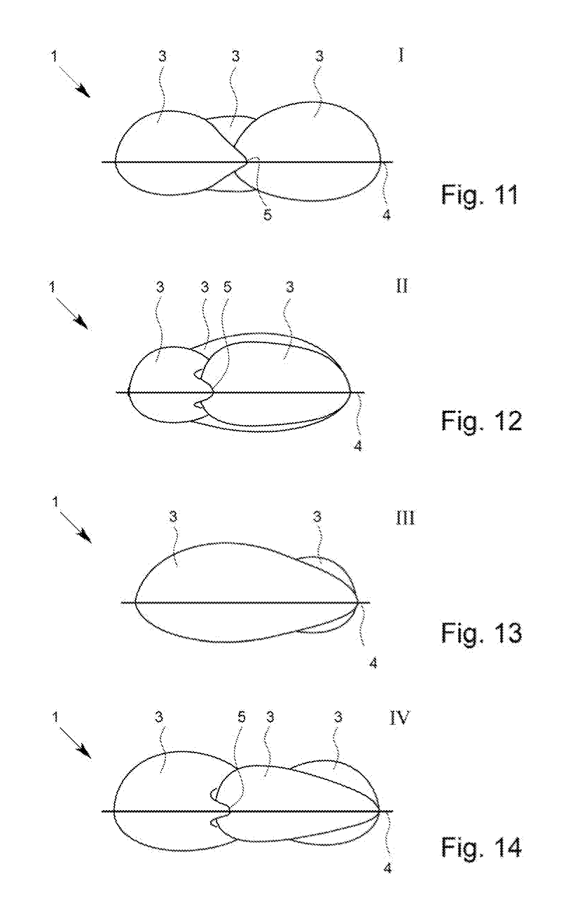

FIGS. 1 to 14 show different embodiments of detergent products 1 for treating textiles, in the form of single-use portion packs. Such a portion pack is used only once for treating textiles, usually in a textile washing machine. Each detergent product 1 comprises a film pouch 2 having four pouch chambers 3 (FIGS. 1 to 7) or three pouch chambers 3 (FIGS. 8 to 14). Accommodated in the pouch chambers 3 are detergent preparations which may contain active washing substances for treating textiles, in particular for washing textiles. Water-soluble PVA films with the type designation M8630 or M8720 from the film manufacturer Monosol can be used to produce the film pouch 2. Alternatively, suitable water-soluble films from other film manufacturers, such as for example Aicello, Nippon Gohsei or Mondi, can also be used.

The film pouch 2 is formed of two water-soluble films, which may be in the form of PVA films. The water-soluble films enclose the pouch chambers 3 by forming the boundary walls thereof. The films are connected to one another in the region of sealing sections 4 in such a way that the pouch chambers 3 are each sealed and separated from one another around the entire circumference by the sealing sections 4. Thus, between two adjacent pouch chambers 3, in each case a sealed film section is also provided, which connects the pouch chambers 3 to one another in order to achieve a single portion pack.

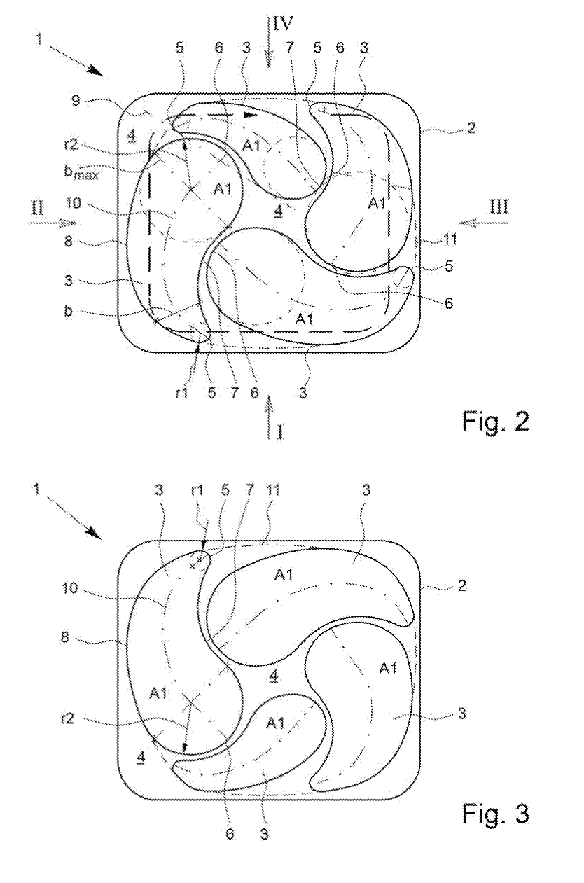

The pouch chambers 3 have different footprints A1 in the sealing plane or connecting plane between the films (FIGS. 2, 3; 9, 10), while the total detergent product 1 or film pouch 2 has the footprint A2 in the sealing plane. The footprint A1 of a pouch chamber 3 is delimited by the contour line of the respective pouch chamber 2 in the sealing plane. The footprint A2 of the (total) detergent product 1 is delimited by the contour line thereof in the sealing plane. In the embodiments shown, a substantially square footprint A2 of the detergent product 1 is provided with rounded corner regions.

In all the embodiments shown, the footprints A1 of the pouch chambers 2 are each droplet-shaped or teardrop-shaped with a narrow convex end section 5 of the contour line of the respective pouch chamber 3 in the sealing plane (having a smaller inner radius r1) and with a wider convex end section 6 (having a larger inner radius r2) located opposite this in the longitudinal direction of the pouch chamber 3. Provided between the two convex sections 5, 6 at the ends of the pouch chamber 3 is a concave or possibly even straight connecting section 7 radially on the inside and a convex or straight connecting section 8 radially on the outside.

The different product designs of the detergent products 1 shown in FIGS. 1 to 14, that is to say in particular the geometric configuration (shape), the size and the arrangement of the pouch chambers 3 relative to one another, will be explained in detail below.

All the embodiments shown have the common feature that an arrangement is provided which comprises three or more pouch chambers 3 arranged one after the other, which form a series of pouch chambers 3 with a monotonously increasing size of the footprints A1 of the pouch chambers 3 located in the sealing plane and with a monotonously increasing size of the fill volumes of the pouch chambers 3.

In the embodiments shown in FIGS. 1 to 7, four pouch chambers 3 are provided, which are located one after the other in the circumferential direction (arrow 15) of the film pouch 2 and form the series of pouch chambers 3. The pouch chamber 3 shown at the top in FIG. 2 has the smallest footprint A1 and the smallest fill volume, and the pouch chamber 3 shown on the right in FIG. 2 has a medium size of the footprint and a medium size of the fill volume. The subsequent third pouch chamber 3 shown at the bottom in FIG. 2 then has a maximum size of the footprint A1 and a maximum size of the fill volume. The size of the footprint A1 and the size of the fill volume of the fourth pouch chamber 3 shown on the left in FIG. 2 substantially or identically corresponds to the size of the footprint A1 and to the size of the fill volume of the third pouch chamber 3 shown at the bottom in FIG. 2. As a result, a series of pouch chambers 3 comprising four successive elements is formed, wherein the pouch chambers 3 are arranged one after the other in the circumferential direction (arrow 12) of the film pouch 2 according to the size of the respective footprint and the size of the respective fill volume. The circumferential direction follows the outer contour of the film pouch 2 in the sealing plane. The pouch chambers 3 are arranged around a middle sealing section 4 of the film pouch 2.

What is not shown is that in principle all the pouch chambers 3 of the film pouch 2 may also have a differently sized footprint A1 and/or a differently sized fill volume. The pouch chambers 3 then form a series of pouch chambers 3 comprising n successive elements, where n≥3, and where the footprint and/or the fill volume of each subsequent pouch chamber 3 of the series is larger than the footprint A1 and/or the fill volume of an adjacent preceding pouch chamber 3 or increases strictly monotonously.

The increase in the size of the footprint A1 and/or the increase in the size of the fill volume of the pouch chambers 3 in the series preferably corresponds to a mathematical formation rule, namely to a function which clearly describes the relationship between the position and/or arrangement of the respective pouch chamber 3 in the series and the size of the footprint A1 and/or of the fill volume of the respective pouch chamber 3.

By virtue of the pouch chambers 3 being arranged successively in the circumferential direction with a monotonously or possibly strictly monotonously increasing size of the footprints A1 and/or size of the fill volume, a product design is achieved which is characterized by a high intrinsic stability, a pleasing external appearance and a very good dissolution behavior when used in a textile washing machine.

In order to further increase the intrinsic stability and to obtain a compact structure of the detergent product 1 with narrow sealing sections 4 between the pouch chambers 3, the footprints A1 of the pouch chambers 3 each have an axially asymmetrical droplet shape. The arrangement of the footprints A1 on the film pouch 2 is rotationally asymmetrical. The aforementioned geometric features of the pouch chambers 3 and of the arrangement thereof relative to one another not only lead to an esthetically pleasing appearance from the user's point of view but also result in an even and intensive flow around and over the pouch chambers, which is associated with a fast and largely complete dissolution of the film material during a wash cycle in a textile washing machine. By ordering pouch chambers 3 with a (possibly strictly) monotonously increasing size of the footprint and/or with a (possibly strictly) monotonously increasing size of the fill volume, it is possible to reduce the risk that parts of laundry, such as buttons and/or appliques, will become caught between adjacent pouch chambers 3 during a wash cycle. As a result, the detergent product 1 is moved and washed around more intensively during a wash cycle, which ensures a good dissolution behavior.

Particularly when the increase in the size of the footprint A1 and/or the increase in the size of the fill volume in the series of pouch chambers 3 corresponds to the formation rule for a mathematical sequence of numbers, a product design will be obtained which to the human eye appears to be an esthetic distribution of pouch chambers 3 with different chamber volumes.

In the embodiment shown in FIGS. 1 to 7, the pouch chambers 3 are arranged around an uninterrupted sealing section 4 which is provided in the middle region of the film pouch 1. The pouch chambers 3 are arranged one next to the other in the circumferential direction (arrow 12) of the film pouch 2 and do not overlap one another. All the pouch chambers 3 have a different fill volume and a different spatial shape.

As already mentioned, the footprint A1 of each pouch chamber 3 is axially asymmetrical. The footprint A1 may be droplet-shaped in each case. Based on a circular shape of smaller inner radius r1 located in the sealing plane at the narrow convex end section 5 of the contour of the pouch chamber 3 and a circular shape of larger inner radius r2 located at the wider convex end section 6, the ratio of the larger inner radius r2 to the smaller inner radius r1 may be the same for all pouch chambers 3 or may vary in the circumferential direction of the film pouch 2. The ratio may lie in the range between 3:1 and 10:1, for example around 5:1 according to FIG. 2. In the embodiments shown in FIGS. 8 to 14, the ratios are larger and are different for the pouch chambers 3.

As can also be seen from FIG. 2, adjacent pouch chambers 3 are arranged relative to one another in such a way that the wider convex end section 6 of the contour of a first pouch chamber 3 is located opposite the concave connecting section 7 of a subsequent second pouch chamber 3 in the circumferential direction. The narrower convex end section 5 of the subsequent second pouch chamber 3 is offset radially outward in relation to the wider convex end section 6 of the first pouch chamber 3 with respect to the area bisectors 10 of the two footprints A1 of the adjacent pouch chambers 3. Here, the starting point of the area bisector 10 of the footprint A1 at the narrow end of a subsequent pouch chamber 3 in the circumferential direction of the film pouch 2 is offset radially outward in relation to the end point of the area bisector 10 of the footprint A1 at the wide end of a preceding pouch chamber 3.

The wider convex end section 6 of the contour of a preceding pouch chamber 3 in the sealing plane additionally intersects a tangent 9 which is placed at the narrow convex end section 5 and at the wide convex end section 6 of the contour of a subsequent pouch chamber 3 and thus extends into a concave region of the subsequent pouch chamber 3.

The connecting sections 7, 8 of the contours of all pouch chambers 3 in the sealing plane have the same direction of curvature from the narrow convex end section 5 to the wide convex end section 6 of the respective pouch chamber 3. The same applies to the area bisector 10. As shown in FIG. 2, when viewed from above, this results in a right-turning arrangement of the footprints A1 of the pouch chambers 3 in the direction from the narrow convex end section 5 to the wide convex end section 6 (or in a corresponding left-turning arrangement when viewing the film pouch 2 from below as shown in FIG. 3). It will be understood that a left-turning arrangement of the footprints A1 of the pouch chambers 3 may also be provided in plan view.

It can also be seen from FIG. 2 that the width b of the footprint A1 of each pouch chamber 3 transverse to the area bisector 10 first increases continuously from the narrow convex end section 5 toward the wide convex end section 6, until a maximum width is reached. The width then decreases continuously again toward the wide convex end section 6. The same applies to the cross-sectional area perpendicular to the sealing plane. From a narrow end of the pouch chamber 3 (cross-sectional area=0) toward a wide end of the pouch chamber 3 (cross-sectional area=0), the cross-sectional area first increases in the longitudinal direction of the pouch chamber 3 with a relatively small gradient over a relatively large length, until a maximum cross-sectional area of the pouch chamber 3 is reached, and, after reaching the maximum cross-sectional area, decreases again with a larger gradient over a shorter length until it reaches zero at the wider end of the pouch chamber 3. This is then followed by the subsequent pouch chamber 3 having an identical or similar cross-sectional profile, wherein the maximum cross-sectional area of the subsequent pouch chamber 3 is in each case larger than the maximum cross-sectional area of a preceding pouch chamber 3. This applies to the pouch chambers 3 shown at the top, on the right and at the bottom in FIG. 2. The maximum cross-sectional area of the pouch chamber 3 shown on the left in FIG. 2 then corresponds again substantially to the maximum cross-sectional area of the pouch chamber 3 shown at the bottom in FIG. 2.

The geometry of the pouch chamber 3 or of the envelope thereof is thus characterized by a helical structure in the direction of curvature of the area bisector 10, both in two-dimensional space in the sealing plane (in a plan view of the footprints A1) and in three-dimensional space (in a perspective view of the pouch chambers 3).

The maximum width of a footprint A1 and/or the maximum cross-sectional area of a pouch chamber 3 may be reached in each case in the region of the mid-point of a circular arc placed from the inside against the wide convex end section 6 of the contour line of the pouch chamber 3 in the sealing plane.

It should also be noted that, in the illustrated detergent products 1, the convex outer connecting sections 8 of the contour lines of the pouch chambers 3 of a film pouch 2 are arranged on a common circumferential line 11 which runs at least substantially in a square or rectangular or super-elliptical shape. Other shapes of the circumferential line 11 are not ruled out. For example, the circumferential line may run in a circular shape. This also contributes to a compact structure. The smallest distance between two pouch chambers 2 following one another in the direction of the circumferential line 11 in the sealing plane may be preferably less than 5 mm, more preferably less than 3 mm, particularly preferably less than 2 mm. Due to the deformations which occur when producing the film pouch 2 by deep-drawing and due to the restoring forces of the film layers, adjacent pouch chambers 3 may even bear partially against one another in the use state of the detergent product 1.

Only the differences between the detergent product 1 shown in the further FIGS. 8 to 14 and the embodiment already described and shown in FIGS. 1 to 7 will be explained in detail below. Coinciding features have been denoted by the same reference signs.

The detergent product 1 shown in the further FIGS. 8 to 14 has three pouch chambers. The pouch chambers 3 are adjacent to one another in a yin-and-yang shape, so that the width of the sealing sections 4 between the pouch chambers 3 is as small as possible. A high intrinsic shape stability is thus achieved. It becomes more difficult to see the narrow sealing sections between the pouch chambers 3.

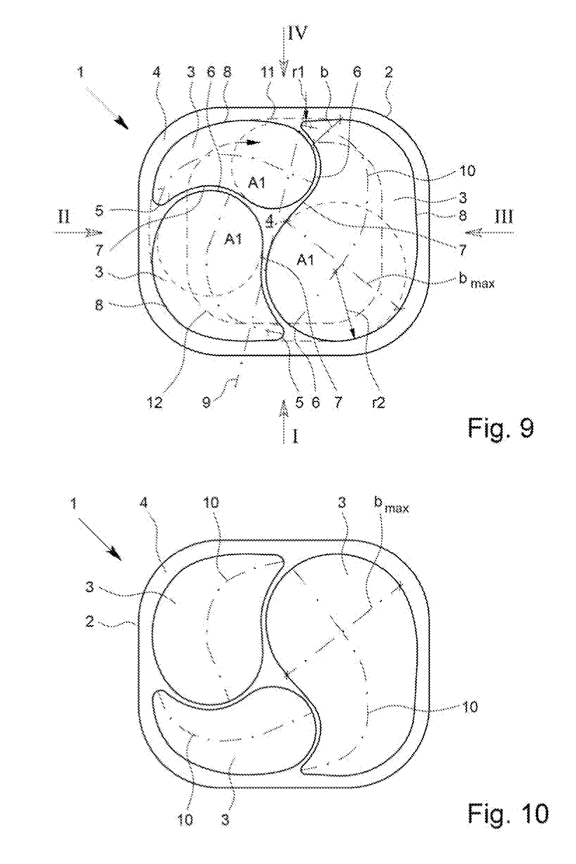

In addition, it is provided according to FIG. 9 that the outer connecting sections 8 of the contour of the pouch chambers 3 are designed as free-form curved sections. The outer connecting sections 8 are located on a substantially square common circumferential line 11. The circumferential line 11 runs substantially parallel to the outer contour of the film pouch 2. A very compact structure of the film pouch 2 is thus achieved, with a tight arrangement of the pouch chambers 3. The footprints A1 of all pouch chambers 3 are arranged in a right-turning manner in a view from above (FIG. 9) or in a left-turning manner in a view from below (FIG. 10) starting from a narrow convex end section 5 along the area bisector 10 toward a wide convex end section 6 of the respective contour line.

In addition, in this embodiment, all the pouch chambers 3 also have differently shaped and differently sized footprints A1 and different fill volumes.

What is not shown is that, between the pouch chambers 3 of the embodiments shown in FIGS. 1 to 14, a central chamber may be provided in the middle region of the film pouch 2, which central chamber forms a further chamber of the multi-chamber arrangement of the film pouch 2. Together with the pouch chambers 3, the central chamber can form a (finite) series of chambers located directly one after the other, with a monotonously increasing size of the footprint A1 located in the sealing plane and/or with a monotonously increasing size of the fill volume.

### LIST OF REFERENCE SIGNS

1 detergent product
2 film pouch
3 pouch chamber
4 sealing section
5 end section
6 end section
7 connecting section
8 connecting section
9 tangent
10 area bisector
11 circumferential line
12 arrow

What is claimed is:

1. A detergent product comprising a film pouch having a plurality of pouch chambers which are each enclosed by at least one water-soluble film, wherein the pouch chambers are formed by water-soluble films connected to one another in a sealing plane and are separated from one another by sealing sections located in the sealing plane, and wherein the pouch chambers are each filled with a detergent preparation, characterized in that a plurality of pouch chambers which are located one after the other are provided in a number n where n≥3, which pouch chambers are arranged as a series of pouch chambers with a monotonously increasing size of the footprints of the pouch chambers located in the sealing plane and/or with a monotonously increasing size of the fill volumes of the pouch chambers.

2. The detergent product according to claim 1, characterized in that pouch chambers which are located one after the other in the circumferential direction of the film pouch form the series of pouch chambers.

3. The detergent product according to claim 1, characterized in that, in the series of pouch chambers, a number of m pouch chambers, where m<n, are provided which have an identical size of the footprints located in the sealing plane and/or an identical size of the fill volumes.

4. The detergent product according to claim 1, characterized in that a plurality of pouch chambers which are located one after the other are provided in a number n where n≥3, which pouch chambers form a series of pouch chambers with a strictly monotonously increasing size of the footprints of the pouch chambers located in the sealing plane and/or with a strictly monotonously increasing size of the fill volumes of the pouch chambers.

5. The detergent product according to claim 1, characterized in that the increase in the size of the footprints and/or the increase in the size of the fill volumes of the pouch chambers in the series of pouch chambers corresponds to the formation rule for a sequence of numbers.

6. The detergent product according to claim 1, characterized in that the increase in the size of the footprints and/or the increase in the size of the fill volumes of the pouch chambers in the series of pouch chambers correlates with the sequence of prime numbers or with the Fibonacci sequence of numbers.

7. The detergent product according to claim 1, characterized in that at least two pouch chambers of the series of n pouch chambers have footprints of different shape.

8. The detergent product according to claim 1, characterized in that the footprint of at least one pouch chamber of the series of pouch chambers is axially asymmetrical.

9. The detergent product according to claim 1, characterized in that the footprint of the pouch chamber is droplet-shaped or leaf-shaped or yin-and-yang-shaped.

10. The detergent product according to claim 1, characterized in that the arrangement of the footprints of the pouch chambers in the sealing plane is rotationally asymmetrical.

11. The detergent product according to claim 1, characterized in that an area bisector of the footprint turns to the left or to the right, and in that a left-turning or right-turning arrangement of all pouch chambers is provided.

12. The detergent product according to claim 1, characterized in that the width of the footprint transverse to an area bisector of the footprint and/or the cross-sectional area of the pouch chamber perpendicular to the sealing plane first increases over a section of the length of the area bisector and decreases after reaching a maximum value.

13. The detergent product according to claim 1, characterized in that at least one central chamber is provided which is arranged in the middle region of the film pouch, and in that the pouch chambers are arranged around the central chamber.

14. The detergent product according to claim 1, characterized in that the central chamber and the pouch chambers form a finite series of chambers located directly one after the other with a monotonously increasing size of the footprints of the chambers located in the sealing plane and/or with a monotonously increasing size of the fill volumes of the chambers.

15. The detergent product according to claim 14, characterized in that a total number of 3 to 10 chambers is provided.

16. The detergent product according to claim 1, comprising a film pouch having a plurality of pouch chambers which are each enclosed by at least one water-soluble film, wherein the pouch chambers are formed by water-soluble films connected to one another in a sealing plane and are separated from one another by sealing sections located in the sealing plane, and wherein the pouch chambers are each filled with a detergent preparation, characterized in that a plurality of pouch chambers which are located one after the other are provided in a number n where n≥3, which pouch chambers are arranged as a series of pouch chambers with a monotonously increasing size of the footprints of the pouch chambers located in the sealing plane and/or with a monotonously increasing size of the fill volumes of the pouch chambers.

17. The detergent product according to claim 1, comprising a film pouch having a plurality of pouch chambers which are each enclosed by at least one water-soluble film, wherein the pouch chambers are formed by water-soluble films connected to one another in a sealing plane and are separated from one another by sealing sections located in the sealing plane, and wherein the pouch chambers are each filled with a detergent preparation, characterized in that a plurality of pouch chambers which are located one after the other are provided in a number n where n≥3, which pouch chambers are arranged as a series of pouch chambers with a monotonously increasing size of the footprints of the pouch chambers located in the sealing plane and/or with a monotonously increasing size of the fill volumes of the pouch chambers.

18. The detergent product according to claim 3, characterized in that, in the series of pouch chambers, a number of m pouch chambers, where m=2, are provided which have an identical size of the footprints located in the sealing plane and/or an identical size of the fill volumes

19. The detergent product according to claim 7, characterized in that all pouch chambers of the series of n pouch chambers have footprints of different shape.

20. The detergent product according to claim 8, characterized in that the footprints of all pouch chambers of the series of pouch chambers is axially asymmetrical.
